(19) United States
(12) Patent Application Publication
(10) Pub. No.: US 2011/0139067 A1
(43) Pub. Date: Jun. 16, 2011

(54) ARRANGEMENT FOR COATING TAPE-SHAPED FILM SUBSTRATES

(75) Inventors: Lutz Gottsman, Grossroehrsdorf (DE); Holger Proehl, Dresden (DE)

(73) Assignee: VON ARDENNE ANLAGENTECHNIK GMBH, Dresden (DE)

(21) Appl. No.: 12/999,431

(22) PCT Filed: Jun. 23, 2009
(86) PCT No.: PCT/EP2009/004515

§ 371 Date: Feb. 15, 2011

(30) Foreign Application Priority Data
Jun. 23, 2008 (DE) 10 2008 029 379.2

(51) Int. Cl. B05C 9/12

(52) U.S. Cl. 118/68

(57) ABSTRACT

An arrangement for coating of sheet-like foil substrates having an unwinding roll and a winding roll between which the foil substrate is guided under sheet tension and a coating station arranged in between the rolls, permits vacuum coating of foil substrates in which surpassing of the maximum substrate temperature is prevented and high quality substrate transport is made possible. The coating station has at least two coating sources arranged in the direction of the sheet run one behind the other opposite the coating site of the foil substrate, and a support element that generates a support force resulting from the sheet tension on the back of the foil substrate as force component. The support element is arranged between two adjacent coating sources on the back of the substrate opposite the coating side and the foil substrate is freely tightened between two support elements.

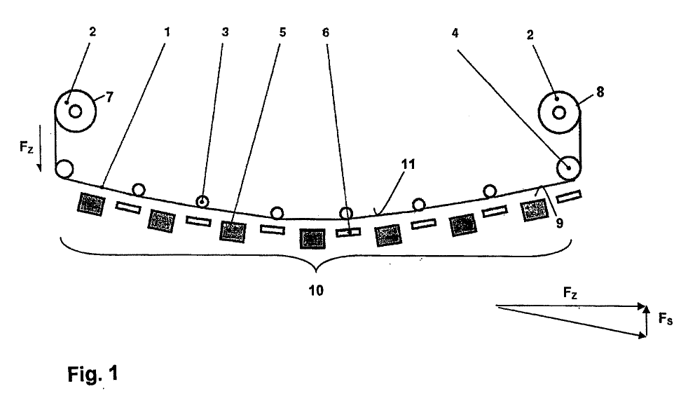

The invention concerns an arrangement for coating of sheet-like foil substrates with an unwinding and winding roll between which the foil substrate is guided under sheet tension and a coating station arranged in between.

For coating a sheet-like foil, substrate is guided in vacuum from an unwinding roll through a coating station and taken up again by a winding roll.

Like any substrate to be coated in a vacuum, a foil substrate to be coated, which especially is a metal foil that can have a thickness of a few tens μm to a few hundred μm, is exposed to a heat load. As a result of the limited thickness, however, overheating phenomena quickly appear in such foil substrates, which regularly lead to structural changes of the substrate. For this reason it must be guaranteed that a maximum substrate temperature during transport and coating of the substrate, and a guarantee of a different lower maximum substrate temperature, is not surpassed before the substrate is wound.

On the other hand, the side of the substrate being coated must also not be subjected to mechanical disturbances, as can be produced, for example, by support or transport rolls. For this reason contact of the substrate side being coated “front side” with rolls or other installation parts during transport, coating or other substrate treatment (for example, cooling) must be avoided.

Finally, during the entire coating process crease-free transport, coating and winding of the substrate must be ensured with consideration of substrate thickness and the admissible substrate temperatures.

The underlying task of the invention is to permit vacuum coating of foil substrates during which surpassing of the maximum substrate temperature is prevented and high quality substrate transport is made possible.

The task is solved by a device with the features of claim 1. claims 2 to 16 show embodiments of the solution according to the invention.

An unwinding and winding roll are provided in the arrangement according to the invention between which the foil substrate is guided under sheet tension. A coating station is arranged in between, i.e., between the unwinding and winding roll. This coating station has at least two coating sources laying one behind the other in the direction of the sheet running in the area of a sheet coating run in which the sheet is guided between the winding roll and the unwinding rolls through the coating station. They lay opposite a coating side of the foil substrate, i.e., they are arranged at a distance from the coating side.

On the other side of the substrate, i.e., on its back side, i.e., the side that is opposite the coating side in the foil substrate, a support element is arranged between two adjacent coating sources, which generates a support force resulting from the sheet tension on the back side of the foil substrate as force component. The foil substrate is freely tightened via the support element. If several support elements are provided, as is generally the case, the foil substrate is then also freely tightened between two support elements. Opposite an exposed surface of the foil substrate and at a distance to the surface, an absorption element that absorbs heat from the substrate is arranged. The heat introduced to the foil substrate by the coating process was removed by this absorption element.

Ordinarily more than two coating sources and corresponding support elements are arranged, the foil substrate having a surface in the sheet coating rod that follows a polygon curve in cross section.

The absorption element can be arranged on the coating side or back side.

It is prescribed on the arrangement on the coating side that the absorption element is arranged between two adjacent coating sources opposite the coating side.

It is prescribed during back side arrangement that the absorption element is arranged in the area of the coating source opposite the back side.

It is also possible here that one or more absorption elements are arranged on both sides so that the cooling effect can be significantly increased.

It is possible to design the absorption element as a cooling traversed by a coolant. The heat absorbed by the absorption element can then be taken off in controlled fashion.

It is expedient if at least one support element is designed as a support roll with its axis of rotation lying across the movement direction of the foil substrate.

Such a support roll can be assigned an additional function, in which the support roll is designed as a cooling roll. This can also be designed traversed by a coolant.

Foil substrates are very sensitive with respect to sheet guiding. They can quickly run off or tend toward distortions. If the support roll is designed as a crowned spreader roll, exact sheet guiding can be supported.

Since the support element or support elements are situated on the back side of the foil substrate, it is possible that at least one support element is designed as a slider lying across the movement direction of the foil substrate.

In principle, it is also possible that at least one support element is designed as a support element that applies the support force in contactless fashion to the back side. This can be achieved by a gas flow element that generates an air cushion between the back side and the support element, especially if the support element is situated outside the vacuum of the coating station.

Another possibility is to generate a magnetic cushion, in which the support element is designed as a magnetic element that produces a spacing between back side of a ferromagnetic metal foil as foil substrate and the support element.

It is also possible that the support element is designed as an electrostatic element that produces a spacing between the back side and the support element.

In principle the sheet winding devices, sheet deflection rolls and sheet cooling rolls are arranged so that only the back side of the sheet is touched by the rolls. This is achieved by selecting the position of all rolls so that the theoretical sag of the sheet defined by the density and sheet tension of the sheet material in the vertical direction always lies above the corresponding roll position.

The coating rate is controlled so that a maximum admissible substrate temperature is not surpassed as a function of substrate thickness, specific heat capacity and substrate speed. Adjacent coating sources are then arranged so that the substrate can cool sufficiently before reaching the first coating source by means of appropriate absorption surfaces or absorption elements by the temperature rise to be expected of the next coating source following the first coating source.

Through the invention an arrangement, drive and control of the surface temperature of active sheet cooling devices (cooling walls) is implemented so that interfering relative movements between the cooling device and substrate are ruled out. In addition, by configuration of substrate guiding a situation is achieved in which the coating side lies freely above the area of the coating source or coating sources. Large surface parts on the back side of the substrate also lie free. The free surface parts on the coating side and/or back side permit arrangement of absorption elements at such a proximity to the surfaces that the substrate is cooled by absorption of radiation heat. Contact and therefore possible surface effects or even damage can be ruled out on this account while guaranteeing cooling. On the other hand it is possible to cool large surface parts by the large percentage of freely lying surface areas. This again permits the use of higher coating power or the use of physical coating processes, like PVD (physical vapor deposition) which per se entail a high thermal substrate load.

PVD coating of thin metal foils especially is made possible by the arrangement according to the invention. Thin metal foils have a thickness of less than 500 μm.

The invention will be further explained below with reference to a practical example. The corresponding drawing shows a sketch of an arrangement according to the invention.

A film substrate 1 is moved by a sheet winding device 2 between the unwinding roll 7 and a winding roll with a sheet tension F_{z}.

Coating sources 5 are arranged opposite the foil substrate 1, i.e., opposite its coating side 9.

Heat-absorbing absorption element 6 are arranged between two adjacent coating sources 5. Most of the heat introduced by each coating source 5 into the foil substrate 1 is absorbed by heat radiation by these absorption element 6. For final cooling a sheet cooling roll 4 is provided at the end of the sheet coating run 9.

On the back 11 of foil substrate 1 support rolls 3 are arranged, specifically always at a distance from the direct connection line to two adjacent rolls, which produces a support force Fₛ from a force triangle via the sheet tension F_{z}, which forces the foil substrate 1 slightly under the support rolls 3.

In principle it is also possible to arrange additional absorption elements 6 on the backside.

### LIST OF REFERENCE NUMBERS

1 Foil substrate

2 Sheet winding device

3 Support roll

4 Sheet cooling roll

5 Coating source

6 Absorption element

7 Unwinding roll

8 Winding roll

9 Coating side

10 Sheet coating run

11 Back side

F_{z} sheet tension

Fₛ Support force

1. Arrangement for coating of a sheet-like foil substrates comprising: an unwinding roll and a winding roll between which the foil substrate is guided under a sheet tension, coating station arranged in between the unwinding roll and the winding roll,
the coating station having at least two coating sources arranged one behind the other in a movement direction of a sheet coating run on a side facing a coating side of the foil substrate,
support element arranged between two adjacent coating sources on a back side of the foil substrate opposite the coating side, the support element producing a support force resulting on the back side of the foil substrate as force component from sheet tension,
the foil substrate being freely tightened between two support elements, and
an absorption element that absorbs heat from the substrate is arranged opposite an exposed surface of the foil substrate and at a distance from the exposed surface.

2. Arrangement according to claim 1, comprising more than two coating sources and corresponding support elements, wherein the foil substrate has a surface in the sheet coating run that follows a polygon curve in cross section.

3. Arrangement according to claim 1, wherein the absorption element is arranged between two adjacent coating sources facing the coating side.

4. Arrangement according to claim 1, wherein the absorption element is arranged in an area of the coating source facing the back side of the foil substrate.

5. Arrangement according to claim 1, wherein the absorption element is a cooling element traversed by a coolant.

6. Arrangement according to claim 1, wherein an absorption element is arranged on each side of the substrate.

7. Arrangement according to claim 1, wherein several absorption elements are arranged opposite an exposed surface of the foil substrate.

8. Arrangement according to claim 1, wherein at least one support element comprises a support roll having an axis of rotation lying across the movement direction of the foil substrate.

9. Arrangement according to claim 8, wherein the support roll is comprises a cooling roll.

10. Arrangement according to claim 9, wherein the cooling roll is traversed by a coolant.

11. Arrangement according to claim 8, wherein the support roll comprises a crowned spreader roll.

12. Arrangement according to claim 1, wherein at least one support element comprises a slider lying across the movement direction of the foil substrate.

13. Arrangement according to claim 1, wherein at least one support element applies the support force to the back side in contactless fashion.

14. Arrangement according to claim 13, wherein the support element comprises a gas flow element that generates an air cushion between the back side and the support element.

15. Arrangement according to claim 13, wherein the support element comprises a magnetic element that produces a spacing between the back side of the foil substrate and the support element, the foil substrate comprising a ferromagnetic metal foil substrate.

16. Arrangement according to claim 13, wherein the support element comprises an electrostatic element that produces a spacing between the back side of the foil substrate and the support element.
